(19) United States
(12) Patent Application Publication
(10) Pub. No.: US 2026/0206730 A1
(43) Pub. Date: Jul. 23, 2026

(54) COLLAPSIBLE NET

(71) Applicant: AOB Products Company, Columbia, MO (US)

(72) Inventors: Mark Dalton, Columbia, MO (US); Dennis Cauley, Fayette, MO (US); Russell Bergeron, Columbia, MO (US); Paul Coryell, Columbia, MO (US); Michael Lindsay, Columbia, MO (US); Timothy S. Kinney, Warrenton, MO (US)

(73) Assignee: AOB Products Company, Columbia, MO (US)

(21) Appl. No.: 19/453,039

(22) Filed: Jan. 20, 2026

Related U.S. Application Data
(60) Provisional application No. 63/747,510, filed on Jan. 21, 2025.

(51) Int. Cl. A01K 77/00

(52) U.S. Cl. CPC A01K 77/005

(57) ABSTRACT

A net (e.g., fishing net) for capturing an object (e.g., a fish), associated components and methods. The fishing net includes a handle having a proximal end, a distal end, and a longitudinal axis extending between the proximal and distal ends. A head includes a frame and a fish receiver supported by the frame. The head is moveably connected to the handle. The head is moveable along the longitudinal axis of the handle between an operational position where a distal end portion of the head is spaced apart distally from the distal end of the handle and a stowed position where the distal end portion of the head and the distal end of the handle are in contact with one another.

### CROSS-REFERENCE TO RELATED APPLICATION

This application claims priority to U.S. Provisional Patent Application No. 63/747,510, filed Jan. 21, 2025, the entirety of which is hereby incorporated by reference.

### FIELD

The present disclosure relates to nets, and more particularly to collapsible nets.

### BACKGROUND

Nets are used by fisherman (user or operators) to land fish.

### SUMMARY

In one aspect, a fishing net comprises a head including a frame and a fish receiver supported by the frame. A handle has a proximal end, a distal end, and a length extending between the proximal and distal ends. The handle has a longitudinal axis. The handle is moveably connected to the head. The handle is moveable axially with respect to the head between an operational position where a distal end portion of the head is spaced apart distally from the distal end of the handle and a stowed position where the distal end portion of the head and the distal end of the handle are in contact with one another.

In another aspect, a fishing net comprises a head including a frame and a fish receiver supported by the frame. The frame includes a yoke. A retainer is carried by the head and is moveable with respect to the head between a first configuration and a second configuration. A handle has a proximal end, a distal end, and a length extending between the proximal and distal ends. The handle has a longitudinal axis, The handle being moveably connected to the head. The handle is moveable axially with respect to the head between a stowed position where a distal end portion of the handle is spaced distally from the yoke and an operational position where the distal end portion of the handle is closer to the yoke than in the stowed position. The retainer is engageable with the handle in the first configuration to retain the handle in the operational position.

In another aspect, a fishing net comprises a handle having a proximal portion, a distal portion, and a length extending therebetween. A head is supported by the handle. The head includes a frame defining a frame opening. The head includes a fish receiver supported by the frame. The frame includes a yoke connected to the handle. The head includes a light reflector portion located distally with respect to the yoke.

Other objects and features of the present disclosure will be in part apparent and in part pointed out herein.

### BRIEF DESCRIPTION OF FIGURES

FIG. 1 is a front view of a fishing net according to one embodiment of the present disclosure;

FIG. 2 is a perspective of the fishing net (without a fish receiver) with a handle of the fishing net in an operational position;

FIG. 3 is an enlarged, fragmentary perspective of the fishing net, with the handle in the operational position of FIG. 2;

FIG. 4 is another enlarged, fragmentary perspective of the fishing net, with the handle in the operational position of FIG. 2;

FIG. 5 is another enlarged, fragmentary perspective of the fishing net, with the handle in the operational position of FIG. 2;

FIG. 6 is an enlarged, fragmentary cross-section of the fishing net, with the handle in the operational position of FIG. 2 (the shaded areas being portions cut by the section plane);

FIG. 7 is a bottom view of a yoke of the fishing net;

FIG. 8 is an enlarged, fragmentary cross-section of the fishing net, with the handle in the operational position of FIG. 2 and a latch in a retaining position (the shaded areas being portions cut by the section plane);

FIG. 9 is similar to FIG. 8, except the latch is in a retracted position;

FIG. 10 is a perspective of the fishing net with the handle in a stowed position; and

FIG. 11 is an enlarged, fragmentary perspective of the fishing net with the handle in the stowed position of FIG. 10.

Corresponding reference characters indicate corresponding parts throughout the drawings.

### DETAILED DESCRIPTION

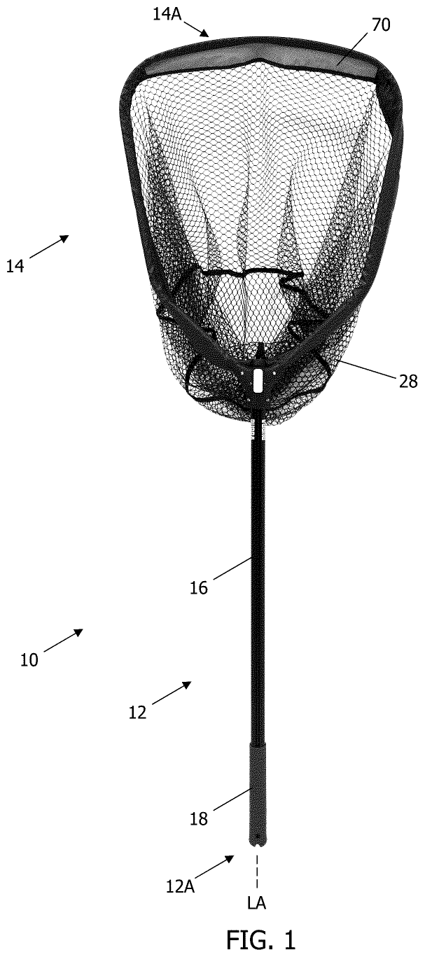

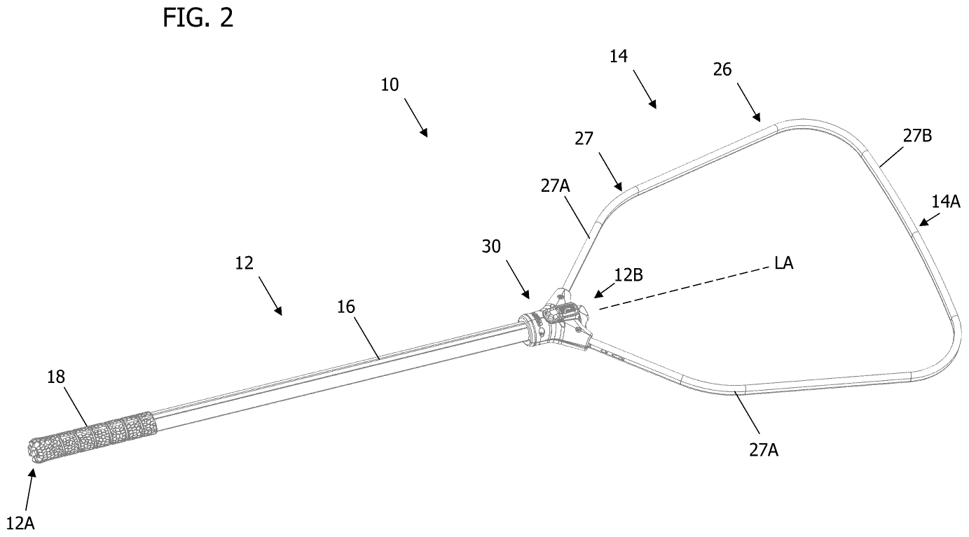

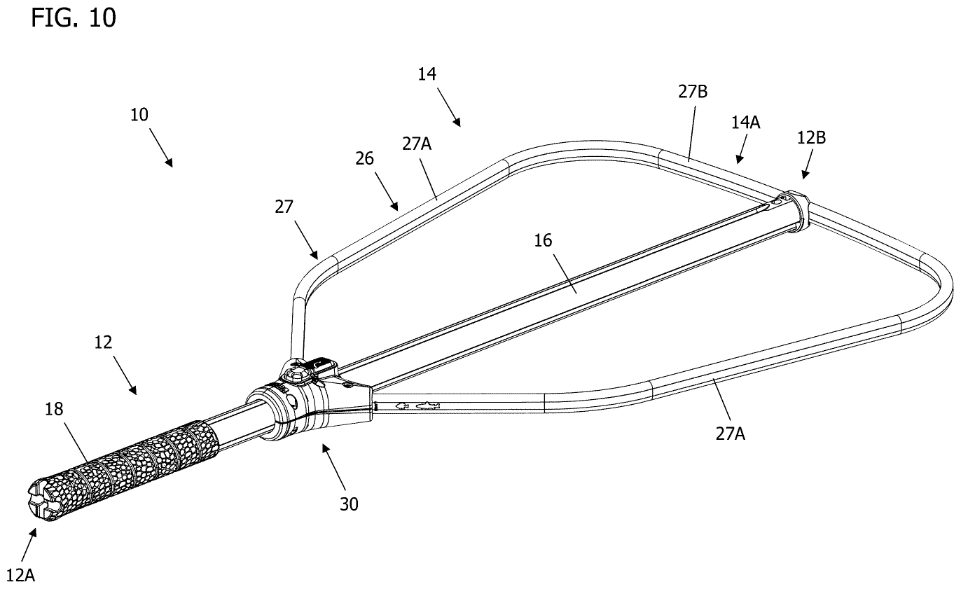

Referring to FIGS. 1 and 2, a net according to one embodiment of the present disclosure is generally indicated by reference numeral 10. The net 10 is used to capture an object (not shown). For example, the net 10 can be used to retrieve a fish from water and, therefore, can be referred to as a fishing net or a landing net. It is understood that the net 10 can be used for other purposes without departing from the scope of the present disclosure. Moreover, it will be appreciated that aspects of the net can be incorporated in nets of other configurations without departing from the scope of the present disclosure. The net 10 of the present disclosure is collapsible to permit the size (e.g., length) of the net to be reduced, such as for storage and/or transportation. The net 10 can be selectively arranged in a first, collapsed, or stowed configuration, as shown in FIG. 10, and arranged in a second, extended, or operational configuration, as shown in FIGS. 1 and 2.

The net 10 includes a handle 12 and a head 14. The handle 12 has a first or proximal end 12A, a second or distal end 12B, and a longitudinal axis LA extending between the proximal and distal ends. The handle 12 includes a pole 16 and a grip 18. The grip 18 is attached to the pole 16. The grip 18 is located adjacent to (e.g., at) the proximal end 12A of the handle 12. In the illustrated embodiment, the grip 18 forms the proximal end 12A of the handle 12. The handle 12 also includes a fitting or insert 20 attached to the pole 16. The fitting is located adjacent to (e.g., at) the distal end 12B of the handle 12. In the illustrated embodiment, the fitting 20 forms the distal end 12B of the handle 12. The fitting 20 is inserted into an end of the pole 16 and secured to the pole, such as with one or more fasteners (e.g., screws, bolts, rivets, etc.). Desirably, the ends of the pole 16 are sealed (such as by the fitting 20 and the grip 18) to prevent water from entering the pole and prevent gas (e.g., air) from leaving the pole so that the handle 12 floats if dropped into the water. The fitting 20 includes or forms a head receiver 22 and a stop 24. The head receiver 22 is at or forms the distal end 12B of the handle 12. The head receiver 22 and the stop 24 will be described in more detail below.

The head 14 includes a frame 26 and an object receiver 28 (e.g., fish receiver), and a yoke or hub 30 and a hoop frame segment 27. The object receiver 28 includes a bag or netting. The object receiver 28 is supported by the frame 26. In particular, the object receiver 28 is connected to the hoop frame segment 27. The object receiver 28 can be connected to the hoop frame segment 27 in any suitable manner. For example, in one embodiment, the hoop frame segment 27 is threaded through one or more sections of the object receiver 28 to connect the object receiver to the frame. The hoop frame segment 27 extends in a substantially hoop shape that defines an opening that serves as the entrance to the object receiver 28. The frame 26 is rigid to maintain the size of the opening to the object receiver 28. The hoop frame segment 27 can be made of any suitable material, such as metal (e.g., aluminum, steel, etc.). The hoop frame segment 27 includes first and second arms 27A that are connected to (broadly, supported by) the yoke 30. The arms 27A extend into the yoke 30 and are secured to the yoke, such as with one or more fasteners. The arms 27A extend away from the yoke and curve turn toward each other distally with respect to the yoke. The hoop frame segment 27 further includes a bridge 27B extending between distal ends of the arms 27A. The bridge 27B is located across the frame opening from the yoke 30 and has a length extending generally transversely with respect to the longitudinal axis of the handle. The yoke 30 is connected to the handle 12. The yoke 30 connects the hoop frame segment 27 and the object receiver 28 (broadly, the head 14) to the handle 12. Other configurations can be used without departing from the scope of the present disclosure.

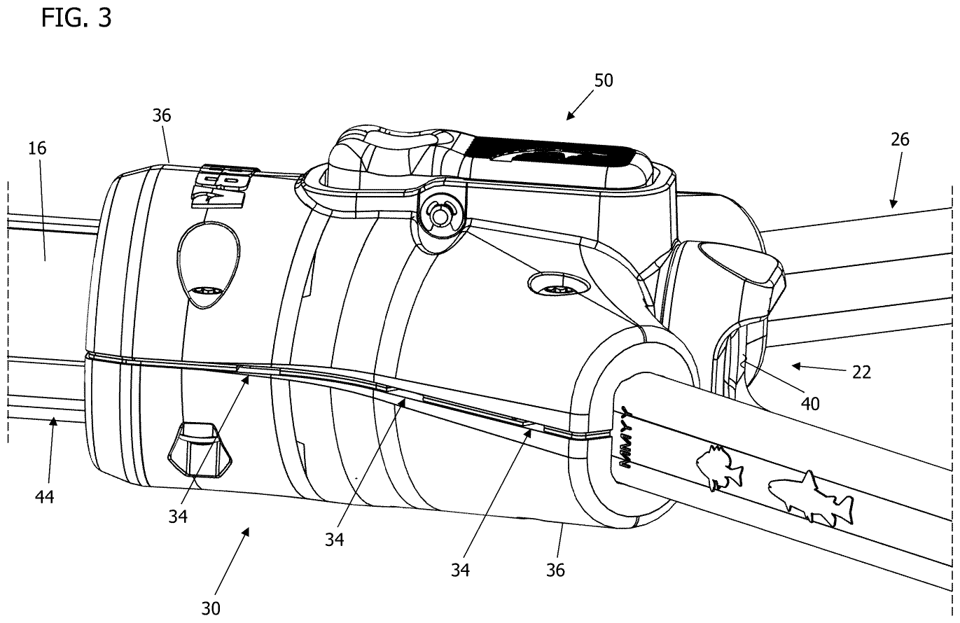

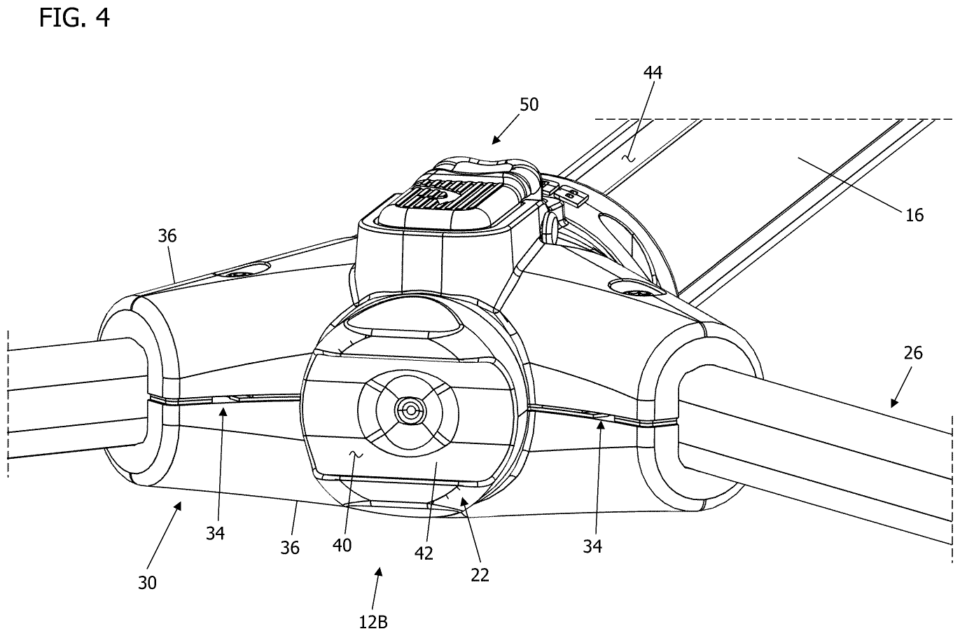

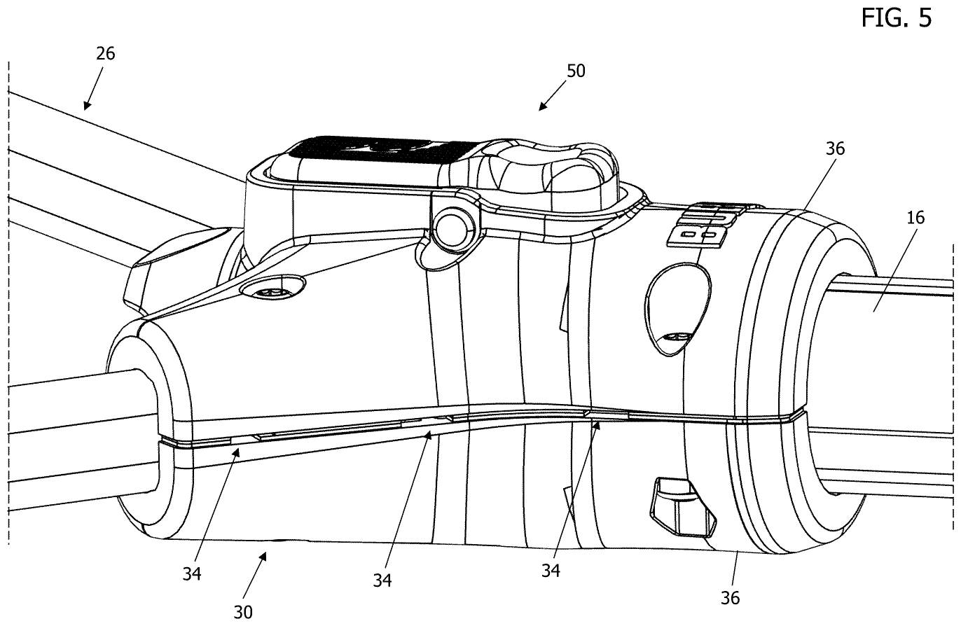

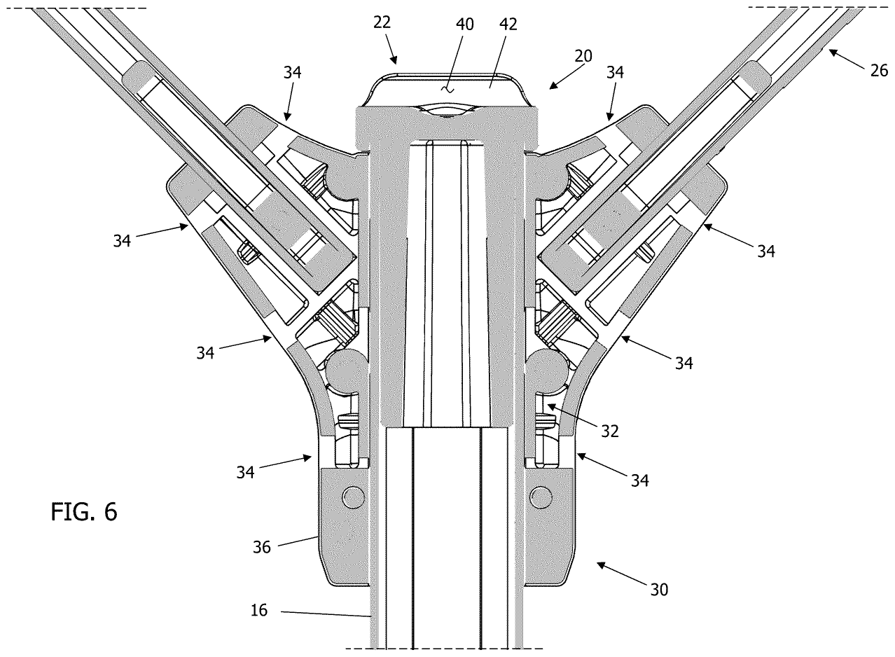

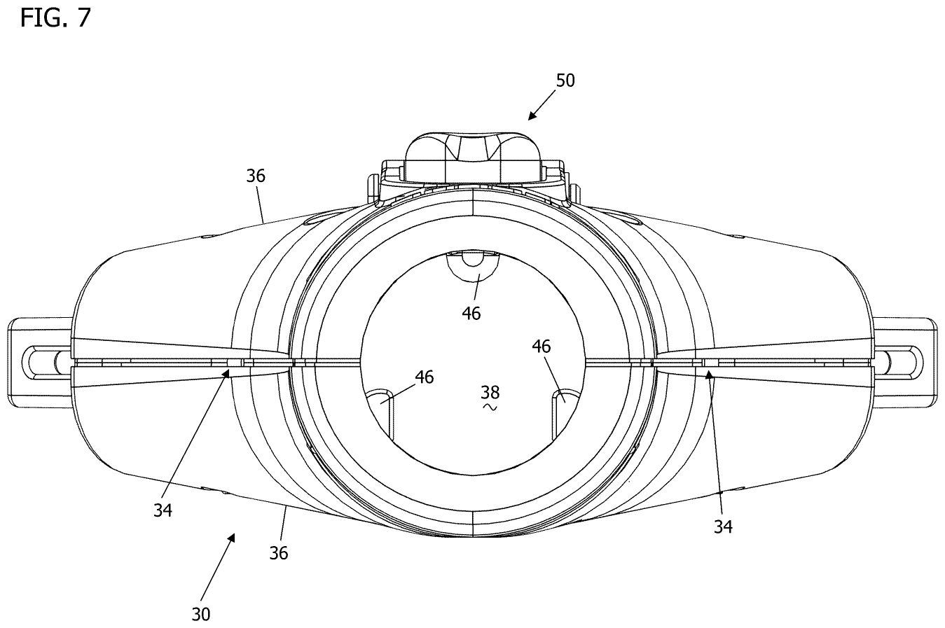

Referring to FIGS. 3-7, the yoke 30 has an interior 32 and at least one drainage port or opening 34. In the illustrated embodiment, the yoke 30 includes a plurality of drainage ports 34. The drainage ports 34 allow fluid (e.g., water) to flow out of the interior 32 of the yoke 30. The drainage ports 34 fluidly connect the interior 32 of the yoke 30 to the ambient or exterior environment to permit fluid (e.g., water) to move out of the interior to the ambient environment through the drainage ports 34. This allows water to freely discharge from the yoke 30, preventing water entrapment in the yoke and extending the useful life of the net 10. The drainage ports 34 are located along the sides of the yoke 30, and are spaced apart along the perimeter of the yoke. In the illustrated embodiment, the yoke 30 is made of two housing or clamshell pieces 36 that are connected together, such as by one or more fasteners. In the illustrated embodiment, the drainage ports 34 are located at the interface of the two clamshell pieces 36. The drainage portions 34 can be formed by recesses in one or both of the clamshell pieces 36 that at the interface (e.g., seam or joint) of the two pieces. Other configurations can be used (e.g., the drainage ports can be omitted or disposed at other locations) without departing from the scope of the present disclosure.

The handle 12 is moveably (e.g., slidably) connected to the head 14. Specifically, the pole 16 is slidable in the yoke 30. This allows the user to arrange the net in the stowed configuration (FIG. 10) and the operational configuration (FIGS. 1 and 2). The handle 12 is moveable with respect to the head 14 between a first or stowed position (FIG. 10) and a second or operational position (FIGS. 1 and 2). The net 10 is in the stowed configuration when the handle 12 is in the stowed position. Similarly, the net 10 is in the operational configuration when the handle 12 is in the operational position. The overall length of the net 10 is shorter or smaller when the handle 12 is in the stowed position, than the operational position, making the net easier to store and/or transport.

The yoke 30 includes a handle connector comprising a handle passage or bore 38. The handle 12 (specifically, the pole 16) extends through the handle passage 38. The pole 16 (broadly, handle 12) is slidable in the handle passage 38 to change the net 10 between the operational and stowed configurations. The handle 12 moves in a forward or distal direction from the operational position toward the stowed position. The handle 12 moves in a rearward or proximal direction from the stowed position toward the operational position. The proximal and distal directions are generally parallel to the longitudinal axis LA.

One of the handle 12 or the head 14 can include a channel or recess 44 and the other of the handle or the head can include a lug or guide 46 disposed in the channel and moveable along (and within) the channel as the handle moves between the operational and stowed positions. This arrangement prevents rotational movement of the handle 12 in the head 14 about the longitudinal axis LA of the handle. In the illustrated embodiment, the handle 12 (specifically, the pole 16) includes the channel 44, and the yoke 30 includes the guide 46. In particular, the handle 12 includes three channels 44 and the yoke 30 includes three guides 46, each guide disposed in one of the channels, although more or fewer can be used without departing from the scope of the present disclosure. More guides 46 can be provided, with multiple guides aligned together as a set that are disposed in the same channel 44. Other configurations (e.g., other ways of inhibiting relative rotation of the handle and the head) can be used without departing from the scope of the present disclosure.

The stop 24 of the handle 12 prevents the handle 12 from sliding rearward out of the yoke 30 (broadly, the head 14). The stop 24 is arranged to engage the yoke 30 to prevent further movement of the handle in the rearward or proximal direction. The stop 24 is wider than the handle passage 38. In the illustrated embodiment, the stop 24 comprises a shoulder or flange outboard of the pole 16. The yoke 30 (broadly, the head 14) can engage the stop 24 when in the operational position. Other configurations can be used without departing from the scope of the present disclosure.

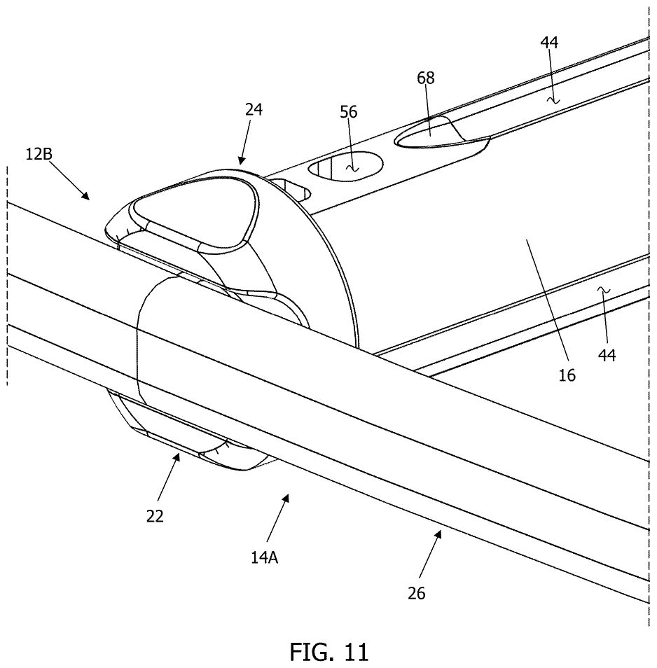

The head receiver 22 of the handle 12 receives the head 14 when the handle is in the stowed position (FIG. 11). The head receiver 22 does not receive the head 14 when the handle is in the operational position. The head receiver 22 has (defines) a head recess 40. The head recess 40 is at the distal end 12B of the handle 12. The head 14 is disposed in the head recess 40 when the head is in the stowed position. In particular, a distal end portion 14A of the head 14 is disposed in the head recess 40 when the handle is in the stowed position. The frame 26 forms at least a portion of the distal end portion 14A of the head 14. In the illustrated embodiment, the fish receiver 28 also forms a portion of the distal end portion 14A of the head 14. The distal end portion 14A of the head 14 is opposite the yoke 30. The yoke 30 forms the proximal end portion (specifically, proximal end) of the head 14.

Referring to FIGS. 1 and 2, in the operational position, the distal end portion 14A of the head 14 is spaced apart distally from the distal end 12B of the handle 12. The yoke 30 is adjacent to the distal end 12B of the handle 12. The head 14 extends distally of the distal end 12B of the handle 12. As illustrated, the frame 26 is shaped such that the frame lies in a plane. The plane is parallel to the longitudinal axis LA of the handle 12 when the handle 12 is in the operational position. The plane extends through the center of the handle 12 (e.g., pole 16).

Referring to FIGS. 10 and 11, in the stowed position, the distal end portion 14A of the head 14 and the distal end 12B of the handle 12 are in contact with one another. This contact prevents the handle 12 from moving farther in the forward or distal direction. Thus, the head receiver 22 also functions as a stop. The head receiver 22 is nests with the head 14. The distal end portion 14A of the head 14 is in the head recess 40. A distal face or engagement surface 42 of the head receiver 22 is in contact with the distal end portion 14A of the head 14. The portion of the frame 26 forming a part of the distal end portion 14A is disposed in the head recess 40. In the stowed position, the head 14 (specifically, the frame 26) is alongside the handle 12 (specifically, the pole 16). The handle 12 extends over or across the opening for the object receiver 28. The frame 26 is disposed outside the handle 12 (e.g., outside the pole 16) when the handle 12 is in the stowed position. Likewise, the object receiver 28 is disposed outside the handle 12 (e.g., outside the pole 12) when the handle 12 is in the stowed position. The plane the frame 26 lies in is parallel to the longitudinal axis LA of the handle 12 when the handle is in the stowed position. The plane extends through the center of the handle 12 (e.g., pole 16). Other configurations can be used without departing from the scope of the present disclosure.

The rigidity of the frame 26 results in the frame having the same shape when the head 14 is in the operational and stowed positions. The frame 26 has a shape when the head 14 is in the operational position, and the shape of the frame is unchanged (broadly, substantially unchanged) when the head is in the stowed position.

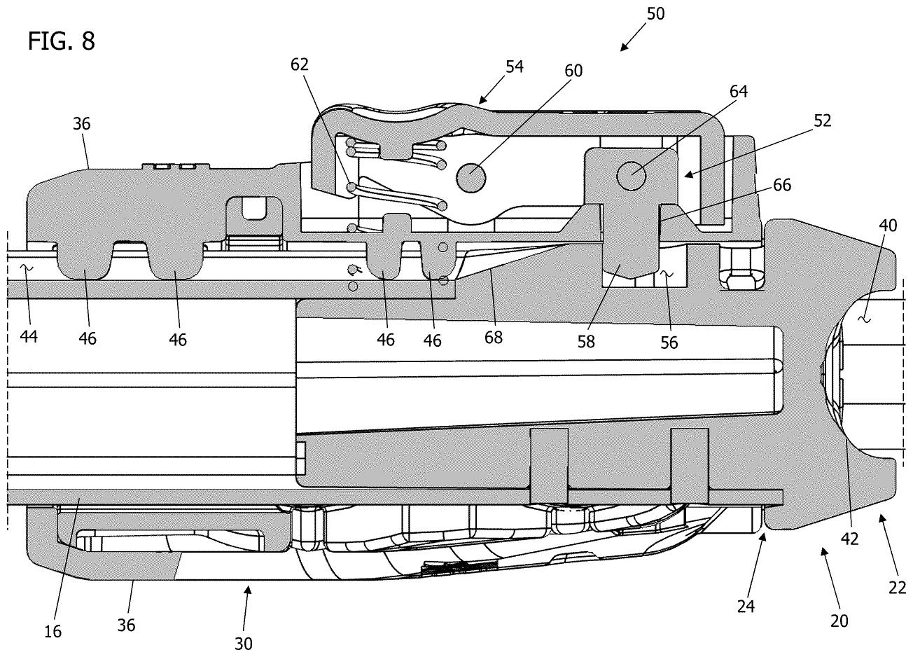

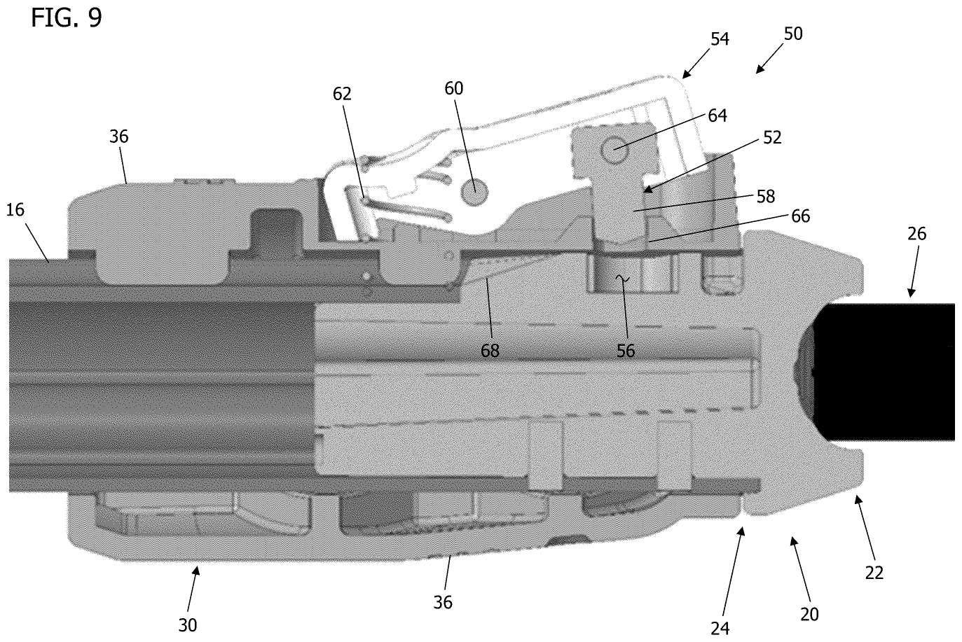

Referring to FIGS. 8 and 9, the net 10 includes a retainer 50 for securing the handle 12 in at least one of the operational position or the stowed position. In the illustrated embodiment, the retainer 50 secures the handle 12 only in the operational position. However, it is understood the retainer can be used to secure the handle 12 in only the stowed position or in both the operational and stowed positions. The retainer 50 is connected to the yoke 30.

The retainer 50 includes a latch 52 and an actuator 54. The retainer 50 is moveable between a first or home configuration (FIG. 8) where the latch is arranged to engage the handle 12 and a second or retracted configuration (FIG. 9) where the latch is retracted from the handle. In the illustrated embodiment, the latch 52 comprises a pin 58 (broadly, protrusion). The handle 12 includes an opening or recess 56 (e.g., blind hole) sized and shaped to receive the pin 58. The opening 56 is defined by a keeper of the handle 12 (the keeper engaging the latch 52 to inhibit the handle 12 from moving in the yoke). When the retainer 50 is in the home configuration and the pin 58 is disposed in the opening 56 (retaining position), the latch secures the handle 12 in the operational position. The latch 52 is moveable to the release configuration to withdraw the pin 58 from the opening 56 so the handle 12 is free to move in the yoke 30.

The actuator 54 is engaged or actuated by the user to move the retainer 50 between the retaining and release configurations. In the illustrated embodiment, the actuator 54 comprises a lever pivotably connected to the yoke 30 by a pivot connection 60. The pivot connection 60 is formed by a shaft or fastener. The actuator 54 includes a press surface or button arranged to be pressed by a finger of the user, to move the retainer 50 toward the release configuration. A spring 62 (e.g., coil spring) biases the retainer 50 toward the retaining configuration. The spring 62 is compressed between the actuator 54 and the yoke 30 (one of the clamshell pieces 36). The pivot connection 60 is disposed between the spring 62 and the latch 52. In the illustrated embodiment, the latch 52 is connected to the actuator 54 by another pivot connection 64 (formed by a shaft or fastener). This allows the latch 52 to pivot slightly relative to the actuator 54 as the retainer moves between the retaining and release configurations. The pin 58 of the latch 52 extends through a guide hole or opening 66 (broadly, guide) in the yoke 30. The guide hole 66 maintains the orientation of the latch 52 to be received by the keeper.

Referring to FIGS. 8, 9, and 11, the handle 12 is configured to move the retainer 50 from the retaining configuration toward the release configuration as the handle 12 is moved toward (and into) the operational position. The user does not need to move the retainer 50 to the release configuration (e.g., press and hold the actuator 54) when moving the handle to the operational position, making it easier to move the handle. The handle 12 includes a ramp 68. The ramp 68 is disposed at one end of one of the channels 44. Together the ramp 68 and the keeper form a retainer receiver. When the handle 12 is not in the operational position and the retainer 50 is in the home configuration, the latch 52 protrudes or extends into the channel 44. The latch 52 rides in the channel 44 as the handle 12 is moved between the operational and stowed positions. As the handle 12 is moved toward the operational position, the latch 52 riding in the channel 44 eventually engages the ramp 68 at the distal end of the channel. The ramp 68 causes the actuator 54 to deflect against the bias of the spring 62 to move the retainer 50 toward (and to) the release configuration. When the latch 52 moves into registration with the keeper (e.g., the opening 56), the spring 62 “snaps” the retainer 50 back toward its home configuration and the latch 52 into its retaining position in the keeper, releasably locking the handle 12 in the operational position. The net 10 is then useable in its operational configuration.

When the user desires to collapse the net 10, the user presses the button portion of the actuator 54 to pivot the latch 52 out of the keeper, enabling the user to slide the handle 12 toward the stowed position. The pin 58 clears the opening 56 of the keeper. Optionally, the latch can engage a similar ramp/keeper arrangement at the proximal end portion of the handle to retain the handle in the stowed position. However, the latch 52 may not retain the handle 12 in the stowed position to facilitate quick and unimpeded extension of the net 10 when needed.

Referring back to FIG. 1, the net 10 can include a light reflector 70 for reflecting light. In the illustrated embodiment, the light reflector 70 is disposed at or adjacent to the distal end portion 14A of the head 14. The light reflector 70 has a length extending along a length of the bridge 27B and extending generally transversely with respect to the longitudinal axis of the handle 12. The light reflector is longer than it is wide and is located adjacent the bridge 27B. The light reflector 70 is attached to the object receiver 28, adjacent the frame 26. The light reflector 70 is located across the frame opening from the yoke 30. The light reflector extends longitudinally along a peripheral edge margin of the frame opening. This positioning aids the user or fisherman in locating the distal end portion 14A of the head 14 (e.g., the bridge 27B or top of the object receiver 28) when trying to capture the object with the net 10 (e.g., land a fish), especially at night. For example, the light reflector 70 can reflect light from a headlamp of the user at night. The user can move the net based on the location of the light reflector relative to the fish to facilitate receiving the fish in the object receiver. Moreover, the fish interrupts the user's vision of the light reflector as the fish moves over the light reflector into the object receiver, helping the user identify that the fish has entered the object receiver. The light reflector can also be used as an emergency “beacon” in low-light/nighttime settings, due to its reflective-to-light capability, for locating purposes such as in search and rescue operations. Other configurations can be used (e.g., the light reflector can be omitted or can have other shapes, orientations, and/or positions) without departing from the scope of the present disclosure. For example, the illustrated light reflector 70 could be a portion of a light reflector that extends more fully around a periphery of the frame opening (including along the arms toward the yoke).

It is appreciated that the person of ordinary skill in the art is readily able to determine the scope of terms of degree such as, but not limited to, “about,” “substantially,” and “generally.” For example, when a term of degree is used in relation to a numeric value, the person of ordinary skill in the art understands that the term of degree covers an inclusive range of plus or minus 10% of the numeric value, unless clearly indicated or stated otherwise.

When introducing elements of the present disclosure or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions and methods without departing from the scope of the disclosure, it is intended that all matter contained in the above description and shown in the accompanying drawings shall be interpreted as illustrative and not in a limiting sense.

What is claimed is:

1. A fishing net comprising:
a head including a frame and a fish receiver supported by the frame; and
a handle having a proximal end, a distal end, and a length extending between the proximal and distal ends, the handle having a longitudinal axis, the handle being moveably connected to the head, the handle being moveable axially with respect to the head between an operational position where a distal end portion of the head is spaced apart distally from the distal end of the handle and a stowed position where the distal end portion of the head and the distal end of the handle are in contact with one another.

2. The fishing net of claim 1, wherein the handle includes a head recess at the distal end of the handle, wherein the distal end portion of the head is disposed in the head recess when the handle is in the stowed position.

3. The fishing net of claim 1, wherein the frame forms at least a portion of the distal end portion of the head.

4. The fishing net of claim 3, wherein the fish receiver forms a portion of the distal end portion of the head.

5. The fishing net of claim 1, wherein the frame has a shape when the head is in the operational position, the shape of the frame being substantially unchanged when the handle is in the stowed position.

6. The fishing net of claim 1, wherein the frame is rigid.

7. The fishing net of claim 1, wherein the frame is disposed outside the handle when the handle is in the stowed position.

8. The fishing net of claim 1, wherein the fish receiver is disposed outside the handle when the handle is in the stowed position.

9. The fishing net of claim 1, wherein the frame lies in a plane, the plane being parallel to the longitudinal axis of the handle when the handle is in the stowed position.

10. The fishing net of claim 9, wherein the plane is parallel to the longitudinal axis of the handle when the handle is in the operational position.

11. The fishing net of claim 9, wherein the plane extends through the center of the handle when the handle is in the stowed position.

12. The fishing net of claim 1, further comprising a retainer configured to secure the handle in at least one of the operational position or the stowed position.

13. The fishing net of claim 12, wherein the retainer is configured to extend in an opening of the handle to secure the handle in the operational position.

14. The fishing net of claim 12, wherein the handle is configured to move with respect to the retainer as the handle moves between the operational and stowed positions.

15. The fishing net of claim 14, wherein the retainer includes a latch and is moveable between a first configuration where the latch is arranged to engage the handle and a second configuration where the latch is retracted from the handle.

16. The fishing net of claim 15, wherein the retainer includes an actuator configured to be engaged by a user to move the latch between the first and second configurations.

17. The fishing net of claim 15, wherein the handle is configured to move the retainer from the first configuration toward the second configuration as the handle is moved toward the operational position.

18. The fishing net of claim 1, wherein the frame includes a yoke connecting the head to the handle, the yoke having an interior and at least one drainage port fluidly connecting the interior to ambient environment to permit fluid to move out of the interior to the ambient environment through the at least one drainage port.

19. A fishing net comprising:
a head including a frame and a fish receiver supported by the frame, the frame including a yoke,
a retainer carried by the head and moveable with respect to the head between a first configuration and a second configuration; and
a handle having a proximal end, a distal end, and a length extending between the proximal and distal ends, the handle having a longitudinal axis, the handle being moveably connected to the head, the handle being moveable axially with respect to the head between a stowed position where a distal end portion of the handle is spaced distally from the yoke and an operational position where the distal end portion of the handle is closer to the yoke than in the stowed position, the retainer being engageable with the handle in the first configuration to retain the handle in the operational position.

20. The fishing net of claim 19, wherein the retainer is biased toward the first configuration.

21. The fishing net of claim 20, wherein the retainer includes a latch and the handle includes a keeper, the latch being configured to be in the keeper when the retainer is in the first configuration and the handle is in the operational position.

22. The fishing net of claim 21, wherein the handle includes a channel extending along the length of the handle, the latch being configured to ride in the channel when the handle is moved toward the operational position.

23. The fishing net of claim 21, wherein the handle includes a ramp configured to engage the latch as the handle is moved toward the operational position.

24. A fishing net comprising:
a handle having a proximal portion, a distal portion, and a length extending therebetween; and
a head supported by the handle, the head including a frame defining a frame opening, the head including a fish receiver supported by the frame, the frame including a yoke connected to the handle, the head including a light reflector portion located distally with respect to the yoke.

25. The fishing net of claim 24, wherein the frame includes a hoop frame segment, the hoop frame segment including first and second arms extending from the yoke and a bridge portion bridging the first and second arms, the bridge portion being located distally with respect to the yoke and having a length extending generally transversely with respect to the length of the handle, the light reflector portion being adjacent the bridge and having a length extending along the length of the bridge portion.
